(19) United States
(12) Patent Application Publication
(10) Pub. No.: US 2024/0266707 A1
(43) Pub. Date: Aug. 8, 2024

(54) SIGNAL TRANSMISSION STRUCTURE, DIELECTRIC WAVEGUIDE CONNECTION STRUCTURE, VEHICLE, AND ELECTRONIC DEVICE

(71) Applicant: Huawei Technologies Co., Ltd., Shenzhen (CN)

(72) Inventors: Yu Liu, Shenzhen (CN); Kun Li, Chengdu (CN); Hao Long, Chengdu (CN)

(21) Appl. No.: 18/640,531

(22) Filed: Apr. 19, 2024

Related U.S. Application Data
(63) Continuation of application No. PCT/CN2022/119558, filed on Sep. 19, 2022.

(30) Foreign Application Priority Data
Oct. 22, 2021 (CN) 202111232671.7

(51) Int. Cl. H01P 5/08; H01P 3/12; H01P 3/16; H01P 5/10

(52) U.S. Cl. CPC H01P 5/087; H01P 3/122; H01P 3/16; H01P 5/1022

(57) ABSTRACT

In accordance with an embodiment, a signal transmission structure includes a connector, a metal waveguide, and a dielectric waveguide. The connector includes a first end and a second end that are oppositely disposed, the connector has a first through hole extending from the first end to the second end, and the first through hole has a metal inner wall. The metal waveguide has a second through hole, one end of the metal waveguide is connected to the first end of the connector, and the second through hole communicates with the first through hole. The dielectric waveguide includes a core and a cladding that covers an outer periphery of the core, and the dielectric waveguide has an insertion end that is inserted into the first through hole through the second end of the connector.

### CROSS-REFERENCE TO RELATED APPLICATIONS

This application is a continuation of International Application No. PCT/CN2022/119558, filed on Sep. 19, 2022, which claims priority to Chinese Patent Application No. 202111232671.7, filed on Oct. 22, 2021. The disclosures of the aforementioned applications are hereby incorporated by reference in their entireties.

### TECHNICAL FIELD

This application relates to the field of signal transmission technologies, and in particular, to a signal transmission structure, a dielectric waveguide connection structure, a vehicle, and an electronic device.

### BACKGROUND

With development of autonomous driving technologies, more sensors, such as a high-definition camera and a laser radar, are used in an autonomous driving system of a vehicle. A large amount of data generated by these sensors in a working process needs to be sent back to an electronic control unit (ECU) of the vehicle, and the electronic control unit performs corresponding control after processing the data. To improve a signal transmission rate, generally, a signal between a sensor and the electronic control unit may be modulated into an electromagnetic wave in a millimeter wave/terahertz wave frequency band, and transmitted by using a dielectric waveguide as a carrier. Specifically, a detection signal of the sensor may be modulated into a millimeter wave/terahertz wave signal via a millimeter wave/terahertz transmitting module, the millimeter wave/terahertz wave signal obtained through modulation is transmitted to a millimeter wave/terahertz receiving module through the dielectric waveguide, and the millimeter wave/terahertz wave signal is demodulated by the receiving module and then transmitted to the electronic control unit.

In the conventional technology, a millimeter wave/terahertz transmitting module and a millimeter wave/terahertz receiving module are generally connected to a dielectric waveguide through a metal connector, and in a connection process, the metal connector is in direct contact with the dielectric waveguide or a core of the dielectric waveguide. Because an electromagnetic field of the dielectric waveguide is mainly concentrated on the dielectric waveguide or the core of the dielectric waveguide, a conductor loss is caused when the metal connector is externally added. In addition, because materials of an outer layer of the dielectric waveguide and the metal connector are different, impedance discontinuity occurs at a joint between the dielectric waveguide and the metal connector, causing a reflection loss.

### SUMMARY

This application provides a signal transmission structure, a dielectric waveguide connection structure, a vehicle, and an electronic device, to reduce a signal loss and improve signal transmission quality.

According to a first aspect, this application provides a signal transmission structure. The signal transmission structure may include a connector, a metal waveguide, and a dielectric waveguide. The connector may include a first end and a second end that are oppositely disposed, a first through hole that extends from the first end to the second end is disposed inside the connector, and the first through hole may have a metal inner wall. The metal waveguide may have a second through hole that penetrates two ends of the metal waveguide. One end of the metal waveguide may be connected to the first end of the connector, and after connection is completed, the second through hole of the metal waveguide may communicate with the first through hole of the connector. The dielectric waveguide may include a core and a cladding that covers an outer periphery of the core. The dielectric waveguide has an insertion end, and the insertion end may be inserted into the first through hole through the second end of the connector. The core may have an extension segment extending out of the cladding at the insertion end of the dielectric waveguide. The extension segment may extend into the second through hole, and an end part of the extension segment is spaced from an inner wall of the second through hole. A cross-sectional area of the end part of the extension segment may gradually decrease in a direction from the second end to the first end of the connector.

In the foregoing solution, at the insertion end of the dielectric waveguide, electric field energy on the dielectric waveguide is gradually concentrated to the end part of the extension segment, and then is gradually coupled to the metal waveguide at the end part of the extension segment. In this way, signal transfer is implemented between the dielectric waveguide and the metal waveguide. Because the cladding separates the core from a metal inner wall of the connector, disturbance caused by a metal boundary to an electromagnetic field in the dielectric waveguide may be reduced. This further reduces a reflection loss, and improves signal transmission quality.

In some possible implementations, the signal transmission structure may have a first cross section and a second cross section, the first cross section may be located between an end part of the cladding and the end part of the extension segment, and the second cross section may be located between the second end of the connector and the end part of the cladding. To ensure that impedance of the signal transmission structure remains in a matching state in an assembly process, an equivalent dielectric constant ε_{eff1} at the first cross section and an equivalent dielectric constant ϵ_{eff2} at the second cross section satisfy:

$$\\ \frac{\vert {ε}_{eff 2} - {ε}_{eff 1} \vert}{{ε}_{eff 2}} \times 100 \% \leq 20 \% .$$

For example, the extension segment may be specifically of a conical structure. Alternatively, the extension segment may include a uniform segment and a gradient segment that are sequentially disposed away from the end part of the cladding, a cross-sectional area of the uniform segment remains unchanged, and the gradient segment is of a conical structure.

In some possible implementations, an end that is of the second through hole and that is close to the connector may have a first hole segment, and an inner diameter of the first hole segment may gradually increase in a direction from the first end to the second end of the connector, to improve a matching degree of connector assembly. During specific disposing, a length of the first hole segment may be greater than or equal to λₒ, where λₒ is a free space wavelength of an operating frequency of a to-be-transmitted signal.

In some possible implementations, an end part of the metal waveguide may be inserted into the first through hole through the first end of the connector, thereby reducing difficulty in connecting the metal waveguide to the connector.

In some possible implementations, a protrusion may be disposed on the inner wall of the first through hole, and the protrusion may have a metal surface. At the insertion end of the dielectric waveguide, the end part of the cladding may be in contact with a side that is of the protrusion and that faces the second end of the connector, and a peripheral side of the extension segment is spaced from a surface of the protrusion. In this way, positioning of the insertion end of the dielectric waveguide may be implemented by using the protrusion.

In some possible implementations, the end part of the metal waveguide may be in contact with a side that is of the protrusion and that faces the first end of the connector. In this way, positioning of the metal waveguide may be implemented by using the protrusion.

In some other possible implementation solutions, there may be a gap between the end part of the metal waveguide and the protrusion, provided that signal transmission quality is not affected.

During specific disposing, the protrusion may be of a ring-shaped structure. In this way, positioning of the dielectric waveguide and the metal waveguide may be implemented in an entire circumferential direction, thereby improving assembly precision of the signal transmission structure.

In some possible implementations, at the end part that is of the metal waveguide and that is inserted into the first through hole, an inner diameter of the second through hole may be approximately equal to an inner diameter of the protrusion, to increase a matching degree of connector assembly.

In some possible implementations, when the extension segment is of the conical structure, the first cross section may be specifically located between the end part of the cladding and the side that is of the protrusion and faces the first end of the connector. When the extension segment includes the uniform segment and the gradient segment, the first cross section may be located between the end part of the cladding and a first plane, where the first plane is a plane closer to the first end of the connector in a plane in which an end of the uniform segment is connected to the gradient segment is located and a plane in which the side that is of the protrusion and that faces the first end of the connector is located.

In some possible implementations, the signal transmission structure may further include a sleeve, and the insertion end of the dielectric waveguide may be fastened in the sleeve. An outer wall of the sleeve may have a first limiting step, the sleeve may be inserted into the first through hole through the second end of the connector, and the first limiting step may be configured to abut against the second end of the connector, thereby implementing positioning of the sleeve on the connector, and further implementing positioning of the insertion end of the dielectric waveguide in the connector. When the metal waveguide is inserted into the first through hole, the end part of the metal waveguide may abut against an end part of the sleeve. In this way, positioning of the metal waveguide may be implemented by using the sleeve.

In some possible implementations, an outer wall of the metal waveguide may have a second limiting step, and the second limiting step may be configured to abut against the first end of the connector, to implement positioning of the metal waveguide in the connector. In addition, in the first through hole, the end part of the cladding of the dielectric waveguide may further abut against the end part of the metal waveguide. In this way, positioning of the dielectric waveguide may be implemented by using the metal waveguide.

In some possible implementations, when the extension segment is of the conical structure, the first cross section may be located between two ends of the first hole segment. When the extension segment includes the uniform segment and the gradient segment, the first cross section may be located between the end part of the cladding and a second plane, where the second plane is a plane closer to the first end of the connector in a plane in which an end of the uniform segment is connected to the gradient segment is located and a plane in which an end part that is of the first hole segment and that is close to the first end of the connector is located.

In some other possible implementations, an end part of the metal waveguide may directly abut against an end part of the connector. During specific implementation, the end part of the metal waveguide and the first end of the connector may be relatively fastened by using a connecting apparatus such as a fastener, a buckle, or a flange.

In some possible implementations, the cladding may include at least one layer structure, and the at least one layer structure may be sequentially stacked in a direction away from the core.

When the cladding includes a single-layer structure, a relative dielectric constant of the cladding may be less than a relative dielectric constant of the core. When the cladding includes two or more layer structures, a relative dielectric constant of at least one layer structure is less than a relative dielectric constant of the core. In this way, electric field energy of a signal transmitted in the dielectric waveguide may be mainly concentrated in the core, and electric field energy distributed in the cladding is less than the electric field energy concentrated in the core. Therefore, when the dielectric waveguide is inserted into the connector, a metal loss caused by the metal inner wall of the connector may be reduced.

In some possible implementations, the metal waveguide may be made of an all-metal material, and the inner wall of the second through hole formed in this case is naturally a metal inner wall. Alternatively, the metal waveguide may be made of a plastic material. In this case, the inner wall of the second through hole has a metallization layer, and a thickness of the metallization layer may be greater than or equal to a skin depth of a millimeter wave or a terahertz wave at an operating frequency of a to-be-transmitted signal, to ensure integrity of signal transfer.

Similarly, the connector may be made of an all-metal material, and the inner wall of the first through hole formed in this case is naturally a metal inner wall. Alternatively, the connector may be made of a plastic material. In this case, the inner wall of the first through hole may be metalized to obtain a metal inner wall.

According to a second aspect, this application further provides a dielectric waveguide connection structure. The dielectric waveguide connection structure may include a first connector assembly, a second connector assembly, and a first metal waveguide. Each connector assembly may include a first connector and a first dielectric waveguide, the first connector may include a first end and a second end that are oppositely disposed, a first through hole extending from the first end of the first connector to the second end is disposed inside the first connector, and the first through hole has a metal inner wall. The first dielectric waveguide may include a first core and a first cladding that covers an outer periphery of the first core, the first dielectric waveguide has an insertion end, and the insertion end may be inserted into the first through hole through the second end of the first connector. The first core has an extension segment extending out of the first cladding at the insertion end of the first dielectric waveguide, and a cross-sectional area of the extension segment may gradually decrease in a direction from the second end to the first end. The first metal waveguide may have a second through hole that penetrates both ends of the first metal waveguide, one end of the first metal waveguide may be connected to a first end of a first connector of the first connector assembly, and the other end of the first metal waveguide may be connected to a first end of a first connector of the second connector assembly. The extension segment of the first connector assembly and an extension segment of the second connector assembly may be separately inserted into the second through hole through the two ends of the first metal waveguide.

In the foregoing solution, when a signal is transmitted from the first connector assembly to the second connector assembly, electric field energy on the first dielectric waveguide of the first connector assembly is concentrated at an end part of the extension segment of the first dielectric waveguide, then is gradually coupled to the first metal waveguide from the end part of the extension segment, propagates along the first metal waveguide, and then is gradually coupled to an extension segment of a first dielectric waveguide of the second connector assembly from the first metal waveguide. In this way, signal transfer is implemented between two first dielectric waveguides. Because the first cladding separates the first core from a metal inner wall of the first connector, disturbance caused by a metal boundary to an electromagnetic field in the first dielectric waveguide may be reduced. This further reduces a reflection loss, and improves signal transmission quality.

In some possible implementations, the second through hole includes a first hole segment, a second hole segment, and a third hole segment, the first hole segment is disposed close to the first connector assembly, the second hole segment is disposed close to the second connector assembly, and the third hole segment is located between the first hole segment and the second hole segment. An inner diameter of the first hole segment and an inner diameter of the second hole segment may gradually increase in a direction away from the third hole segment, to improve a matching degree of assembly of first connectors on both sides of the first metal waveguide.

During specific disposing, a length of the first hole segment may be greater than or equal to λₒ, where λₒ is a free space wavelength of an operating frequency of a to-be-transmitted signal. Similarly, a length of the second hole segment may be greater than or equal to λₒ, and a length of the third hole segment may be greater than or equal to λₒ.

In some possible implementation solutions, one end of the first metal waveguide may be inserted into the first through hole of the first connector of the first connector assembly, and the other end of the first metal waveguide may be inserted into a first through hole of the first connector of the second connector assembly, to reduce difficulty in connecting the first metal waveguide to the first connectors on both sides of the first metal waveguide.

In some other possible implementation solutions, one end of the first metal waveguide may be directly interconnected to the first end of the first connector of the first connector assembly, and the other end of the first metal waveguide may be directly interconnected to a first end of the first connector of the second connector assembly. During specific implementation, an end part of the first metal waveguide and the first end of the first connector may be relatively fastened by using a connecting apparatus such as a fastener, a buckle, or a flange.

According to a third aspect, this application further provides a dielectric waveguide connection structure. The dielectric waveguide connection structure may include a first connector assembly, a second connector assembly, a first metal waveguide, a second metal waveguide, and an intermediate connection assembly. Each connector assembly may include a first connector and a first dielectric waveguide, the first connector may include a first end and a second end that are oppositely disposed, a first through hole extending from the first end of the first connector to the second end is disposed inside the first connector, and the first through hole has a metal inner wall. The first dielectric waveguide may include a first core and a first cladding that covers an outer periphery of the first core, the first dielectric waveguide has an insertion end, and the insertion end may be inserted into the first through hole through the second end of the first connector. The first core has an extension segment extending out of the first cladding at the insertion end of the first dielectric waveguide, and a cross-sectional area of the extension segment may gradually decrease in a direction from the second end to the first end. Each of the two metal waveguides may be provided with a second through hole that penetrates both ends of the metal waveguide. The intermediate connection assembly may include a second connector and a second dielectric waveguide, the second connector may include a first connection end and a second connection end that are oppositely disposed, and a third through hole that penetrates from the first connection end to the second connection end is disposed inside the second connector. The second dielectric waveguide is disposed in the third through hole, the second dielectric waveguide may include a second core and second cladding that covers an outer periphery of the second core, and two ends of the second core separately exceed the second cladding. One end of the first metal waveguide may be connected to a first end of a first connector of the first connector assembly, the other end of the first metal waveguide may be connected to the first connection end, and the extension segment of the first connector assembly and one end that is of the second core and that is close to the first connection end may be separately inserted into the second through hole of the first metal waveguide. One end of the second metal waveguide may be connected to a first end of a first connector of the second connector assembly, the other end of the second metal waveguide may be connected to the second connection end, and an extension segment of the second connector assembly and one end that is of the second core and that is close to the second connection end may be separately inserted into the second through hole of the second metal waveguide.

In the foregoing solution, when a signal is transmitted from the first connector assembly to the second connector assembly, electric field energy on the first dielectric waveguide of the first connector assembly is gradually concentrated to an end part of the extension segment of the first dielectric waveguide, then is gradually coupled to the first metal waveguide from the end part of the extension segment, propagates along the first metal waveguide, is gradually coupled to the second dielectric waveguide from the first metal waveguide, then is coupled to the second metal waveguide from the second dielectric waveguide, propagates along the second metal waveguide, and finally is gradually coupled to the extension segment of the first dielectric waveguide of the second connection assembly from the second metal waveguide. In this way, signal transfer is implemented between two first dielectric waveguides. Because the first cladding separates the first core from a metal inner wall of the first connector, and the second cladding separates the second core from a metal inner wall of the second connector, disturbance caused by a metal boundary to an electromagnetic field in the first dielectric waveguide may be reduced. This further reduces a reflection loss, and improves signal transmission quality.

In some possible implementations, the second through hole includes a first hole segment, a second hole segment, and a third hole segment, the first hole segment is disposed away from the intermediate connection assembly, the second hole segment is disposed close to the intermediate connection assembly, and the third hole segment is located between the first hole segment and the second hole segment. An inner diameter of the first hole segment and an inner diameter of the second hole segment may gradually increase in a direction away from the third hole segment, to improve a matching degree of assembly of first connectors on both sides of the first metal waveguide.

During specific disposing, a length of the first hole segment may be greater than or equal to λₒ, where λₒ is a free space wavelength of an operating frequency of a to-be-transmitted signal. Similarly, a length of the second hole segment may be greater than or equal to λₒ, and a length of the third hole segment may be greater than or equal to λₒ.

In some possible implementation solutions, one end of the first metal waveguide may be inserted into the first through hole of the first connector of the first connector assembly, and the other end of the first metal waveguide may be inserted into a first through hole of the second connector of the intermediate connection assembly, to reduce difficulty in connecting the first metal waveguide to the first connector and the second connector.

Similarly, one end of the second metal waveguide may be inserted into a first through hole of a first connector of the second connector assembly, and the other end of the second metal waveguide may be inserted into the first through hole of the second connector of the intermediate connection assembly, to reduce difficulty in connecting the second metal waveguide to the first connector and the second connector.

In some other possible implementation solutions, one end of the first metal waveguide may be directly interconnected to the first end of the first connector of the first connector assembly, and the other end of the first metal waveguide may be directly interconnected to the first connection end of the second connector. Similarly, one end of the second metal waveguide may be directly interconnected to the first end of the first connector of the second connector assembly, and the other end of the second metal waveguide may be directly interconnected to the second connection end of the second connector.

According to a fourth aspect, this application further provides a vehicle. The vehicle may include a sensor, a transmitting module, a receiving module, an electronic control unit, and the signal transmission structure in any one of the possible implementations of the first aspect. The sensor may be configured to detect movement information of the vehicle. The transmitting module may be electrically connected to the sensor, and is configured to modulate a detection signal of the sensor into a high-frequency signal. There may be two signal transmission structures, where a metal waveguide of one signal transmission structure may be electrically connected to the transmitting module, a metal waveguide of the other signal transmission structure may be electrically connected to the receiving module, and dielectric waveguides of the two signal transmission structures are electrically connected. The receiving module may be configured to: demodulate a received high-frequency signal, and send the demodulated signal to the electronic control unit. The signal transmission structure is used, so that a high-frequency signal may be transmitted between the sensor and the electronic control unit of the vehicle, to meet a requirement for high-speed data transmission between the sensor and the electronic control unit, and improve signal transmission quality.

In some possible implementations, the dielectric waveguides of the two signal transmission structures may be of an integrated structure.

In some other possible implementations, the vehicle may further include the dielectric waveguide connection structure in any possible implementation of the second aspect and the third aspect. In the two signal transmission structures, a dielectric waveguide of one signal transmission structure may be electrically connected to a first dielectric waveguide of a first connector assembly, and a dielectric waveguide of the other signal transmission structure may be electrically connected to a first dielectric waveguide of a second connector assembly, so that dielectric waveguides on both sides of the dielectric waveguide connection structure are electrically connected by using the dielectric waveguide connection structure.

According to a fifth aspect, this application further provides an electronic device. The electronic device may include a server, a switch, a transmitting module, a receiving module, and the signal transmission structure in any one of the possible implementations of the first aspect. The transmitting module may be electrically connected to both the server and the switch, and is configured to modulate a signal sent by the server and a signal sent by the switch into high-frequency signals. There may be two signal transmission structures, a metal waveguide of one signal transmission structure is electrically connected to the transmitting module, a metal waveguide of the other signal transmission structure is electrically connected to the receiving module, and dielectric waveguides of the two signal transmission structures are electrically connected. The receiving module may be electrically connected to both the server and the switch, and is configured to: demodulate a high-frequency signal received from the server, send the demodulated signal to the switch, demodulate the high-frequency signal received from the switch, and send the demodulated signal to the server. The signal transmission structure is used, so that a high-frequency signal may be transmitted between the server and the switch, to meet a requirement for high-speed data transmission between the server and the switch, and improve signal transmission quality.

In some possible implementations, the electronic device may further include an aggregation switch. In this case, the transmitting module may be further electrically connected to the aggregation switch, and is configured to modulate a signal sent by the aggregation switch into a high-frequency signal. The receiving module may be further electrically connected to the aggregation switch, and is configured to: demodulate a high-frequency signal received from the switch, and send the demodulated signal to the aggregation switch; and demodulate a high-frequency signal received from the aggregation switch, and send the demodulated signal to the switch. The signal transmission structure is used, so that a high-frequency signal may be transmitted between the switch and the aggregation switch, to meet a requirement for high-speed data transmission between the switch and the aggregation switch.

### BRIEF DESCRIPTION OF THE DRAWINGS

FIG. 1 is a schematic diagram of a signal transmission path between a vehicle sensor and an ECU according to an embodiment of this application;

FIG. 2 is a schematic diagram of another signal transmission path between a vehicle sensor and an ECU according to an embodiment of this application;

FIG. 3 is a schematic diagram of a structure of a millimeter wave/terahertz transmitting module according to an embodiment of this application;

FIG. 4 is a schematic diagram of a structure of a millimeter wave/terahertz transmitting chip according to an embodiment of this application;

FIG. 5 is a schematic diagram of a structure of a millimeter wave/terahertz receiving chip according to an embodiment of this application;

FIG. 6 is a specific schematic diagram of the signal transmission path between the vehicle sensor and the ECU shown in FIG. 1;

FIG. 7 is a schematic diagram of a structure of a signal transmission structure according to an embodiment of this application;

FIG. 8 is a schematic diagram of a cross-sectional structure at A-A in FIG. 7;

FIG. 9 is a schematic diagram of a cross-sectional structure at B-B in FIG. 7;

FIG. 10 is a schematic diagram of a structure of another signal transmission structure according to an embodiment of this application;

FIG. 11 is a schematic diagram of a structure of another signal transmission structure according to an embodiment of this application;

FIG. 12 is a schematic diagram of a structure of another signal transmission structure according to an embodiment of this application;

FIG. 13 is a schematic diagram of a structure of another signal transmission structure according to an embodiment of this application;

FIG. 14 is a schematic diagram of another signal transmission path between a vehicle sensor and an ECU according to an embodiment of this application;

FIG. 15 is an exploded schematic diagram of a dielectric waveguide connection structure according to an embodiment of this application;

FIG. 16 is a schematic diagram of a structure of the dielectric waveguide connection structure shown in FIG. 15;

FIG. 17 is a schematic diagram of a structure of another dielectric waveguide connection structure according to an embodiment of this application;

FIG. 18 is a partially exploded schematic diagram of another dielectric waveguide connection structure according to an embodiment of this application;

FIG. 19 is a schematic diagram of a structure of the dielectric waveguide connection structure shown in FIG. 18;

FIG. 20 is a schematic diagram of a structure of another dielectric waveguide connection structure according to an embodiment of this application; and

FIG. 21 is a schematic diagram of a structure of an electronic device according to an embodiment of this application.

### DETAILED DESCRIPTION OF ILLUSTRATIVE EMBODIMENTS

To make the objectives, technical solutions, and advantages of this application clearer, the following further describes this application in detail with reference to the accompanying drawings.

With development of autonomous driving technologies, more types of sensors are disposed on a vehicle, including but not limited to a high-definition camera, a laser radar, a millimeter-wave radar, an ultrasonic sensor, and the like. These sensors may be used to detect various movement information of the vehicle in a driving process, for example, a vehicle speed, a wheel speed, and a photographed image of a road condition, a pedestrian, or another vehicle, to support implementation of an autonomous driving function. The foregoing sensors generate a large amount of data (such as pictures and point clouds) in a working process. The data needs to be sent back to an ECU of the vehicle, and the ECU performs corresponding control after analyzing and processing the data.

Because a signal sent by a sensor is generally a baseband signal or a bit stream with a low frequency, with an increase in a data volume, a conventional copper wire transmission technology is difficult to support high-speed data transmission. To resolve this problem, in a current data transmission structure, a signal sent by a sensor is usually modulated into a high-frequency signal with a large bandwidth, and transmitted by using a dielectric waveguide as a carrier, to improve a data transmission rate between the sensor and an ECU. It should be noted that, in embodiments of this application, a high-frequency signal may be understood as a signal with a frequency greater than 3 MHz, for example, including but not limited to an electromagnetic wave in a microwave, millimeter wave, or terahertz wave frequency band. A microwave is an electromagnetic wave in a frequency band from 300 MHz to 300 GHz, and a corresponding wavelength ranges from 1 mm to 1 m. A millimeter wave is an electromagnetic wave in a frequency band from 30 GHz to 300 GHz, and a corresponding wavelength approximately ranges from 1 mm to 10 mm. A terahertz wave is an electromagnetic wave in a frequency band from 0.1 THz to 10 THz, and a corresponding wavelength ranges from 0.03 mm to 3 mm.

FIG. 1 is a schematic diagram of a signal transmission path between a vehicle sensor and an ECU according to an embodiment of this application. On a transmission path between a sensor 1 and an ECU 2, in addition to a dielectric waveguide 31, a transmitting module 4 and a receiving module 5 are usually further disposed. The transmitting module 4 is separately connected to the sensor 1 and one end of the dielectric waveguide 31. The receiving module 5 is separately connected to the other end of the dielectric waveguide 31 and the ECU 2. The transmitting module 4 may be configured to: modulate a signal sent by the sensor 1, perform frequency shifting on the signal to a specified high-frequency frequency band, for example, a microwave frequency band or a millimeter wave/terahertz wave frequency band, couple the modulated high-frequency signal to the dielectric waveguide 31, and transmit the modulated high-frequency signal to the receiving module 5 through the dielectric waveguide 31. The receiving module 5 may perform frequency shifting and demodulation on the high-frequency signal received from the dielectric waveguide, convert the high-frequency signal into a signal in a frequency band that can be received by the ECU 2, and send the signal to the ECU 2.

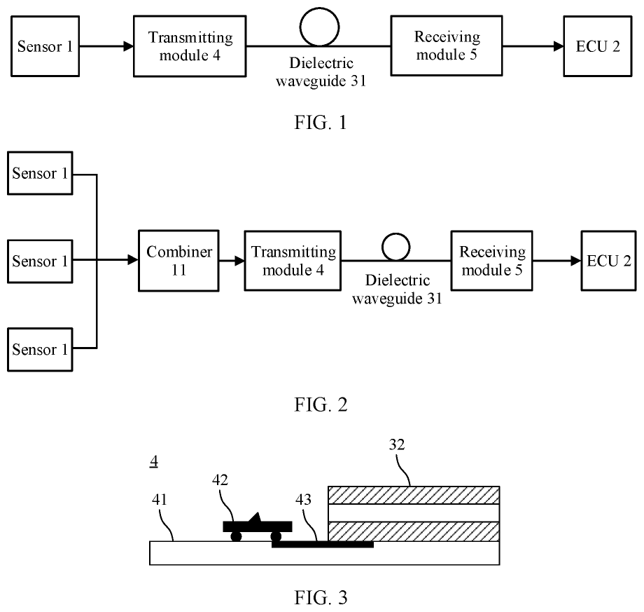

It should be noted that more than one sensor 1 is usually disposed in an autonomous driving system of a vehicle, and when signals of these sensors 1 are transmitted to an ECU, to reduce complexity of transmission paths, signals sent by a plurality of sensors 1 may be transmitted through a same dielectric waveguide. During specific implementation, as shown in FIG. 2, a combiner 11 may be further disposed on the vehicle. The combiner 11 may be disposed between the plurality of sensors 1 and the transmitting module 4, input interfaces of the combiner 11 are separately connected to the plurality of sensors 1, and an output interface of the combiner 11 is connected to the transmitting module 4. In this way, the combiner 11 combines the signals sent by the plurality of sensors 1 and sends a combined signal to the transmitting module 4. Then, the transmitting module 4, the dielectric waveguide 31, and the receiving module 5 sequentially transmit the signal to the ECU 2.

FIG. 3 is a schematic diagram of a structure of the transmitting module according to an embodiment of this application. Refer to FIG. 3. The transmitting module 4 may include a first circuit board 41 and a transmitting chip 42 disposed on the first circuit board 41. The first circuit board 41 may be configured to: supply power to the transmitting chip 42, and transmit a high-frequency signal, a high-speed signal, a control signal, and the like. When the transmitting chip 42 is connected to the dielectric waveguide 31, a transmission line 43 and a metal waveguide 32 may be usually further disposed on the first circuit board 41, and two ends of the transmission line 43 may be respectively connected to the transmitting chip 42 and the metal waveguide 32, to transmit a high-frequency signal transmitted by the transmitting chip 42 to the metal waveguide 32. For example, the transmission line 43 may be specifically a microstrip line, a coplanar waveguide, or a substrate integrated waveguide (SIW). One end that is of the metal waveguide 32 and that is away from the transmission line 43 may be connected to the dielectric waveguide 31. The metal waveguide 32 may be configured to: convert a received high-frequency signal into a signal in a waveguide mode that can be transmitted in the waveguide, and couple the signal in the waveguide mode to the dielectric waveguide 31.

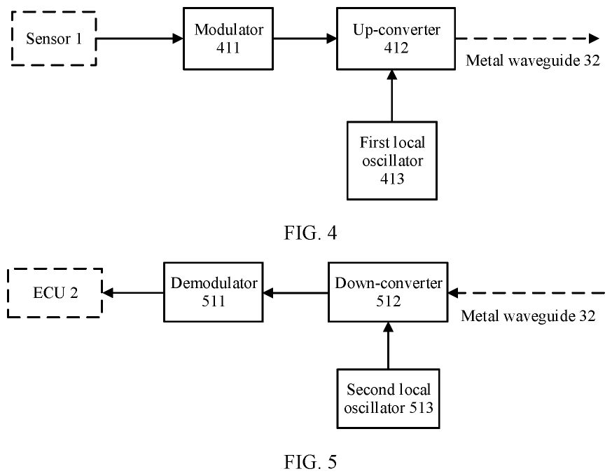

FIG. 4 is a schematic diagram of a structure of the transmitting chip according to an embodiment of this application. As shown in FIG. 4, a modulator 411, an up-converter 412, and a first local oscillator 413 may be integrated on the transmitting chip 42, an input end of the modulator 411 is connected to the sensor 1, an output end of the modulator 411 is connected to one input end of the up-converter 412, the first local oscillator 413 is connected to the other input end of the up-converter 412, and an output end of the up-converter 412 may be connected to the dielectric waveguide through the metal waveguide 32. The modulator 411 may be configured to: perform format modulation on a signal output by the sensor 1, and then output the signal to the up-converter 412. Format modulation includes but is not limited to amplitude/level modulation, phase modulation, quadrature amplitude modulation, or the like. The first local oscillator 413 may generate a high-frequency carrier signal corresponding to an operating frequency of the dielectric waveguide, and the up-converter 412 may perform frequency shifting on an output signal of the modulator 411 by using the carrier signal generated by the first local oscillator 413, and couple the signal to the dielectric waveguide through the metal waveguide 32. An amplifier may be usually further included between the up-converter 412 and the metal waveguide 32. An input end of the amplifier may be connected to the output end of the up-converter 412, and an output end of the amplifier may be connected to the dielectric waveguide through the metal waveguide 32. The amplifier may be configured to amplify an amplitude of a signal output by the up-converter 412, to increase a transmission distance.

Similarly, the receiving module may include a second circuit board and a receiving chip disposed on the second circuit board. When the receiving chip is connected to the dielectric waveguide, a transmission line and a metal waveguide may be further disposed on the second circuit board, and two ends of the transmission line may be respectively connected to the receiving chip and the metal waveguide. One end that is of the metal waveguide and that is away from the transmission line may be connected to the dielectric waveguide, so that a waveguide signal coupled by the dielectric waveguide to the metal waveguide is converted into a high-frequency signal, and the high-frequency signal is transmitted to the receiving chip through the transmission line.

FIG. 5 is a schematic diagram of a structure of a receiving chip according to an embodiment of this application. As shown in FIG. 5, a demodulator 511, a down-converter 512, and a second local oscillator 513 may be integrated on the receiving chip. An input end of the down-converter 512 is connected to the dielectric waveguide through the metal waveguide 32, the other input end of the down-converter 512 is connected to the second local oscillator 513, an output end of the down-converter 512 is connected to an input end of the demodulator 511, and an output end of the demodulator 511 is connected to the ECU 2. The metal waveguide 32 converts a waveguide signal received from the dielectric waveguide into a high-frequency signal, and then transmits the high-frequency signal to the down-converter 512. The second local oscillator 513 may generate a signal corresponding to a signal frequency band that can be received by the ECU 2. The down-converter 512 may perform frequency shifting on the high-frequency signal by using the signal generated by the second local oscillator 513, and send the frequency-converted signal to the demodulator 511. The demodulator 511 performs format modulation on the signal and outputs the signal to the ECU 2. A low-noise amplifier may be usually further included between the down-converter 512 and the metal waveguide 32. An input end of the low-noise amplifier may be connected to the dielectric waveguide through the metal waveguide 32, and an output end of the low-noise amplifier may be connected to the output end of the down-converter 512. The low-noise amplifier may be configured to: amplify an amplitude of a received high-frequency signal, and improve sensitivity of the receiving chip.

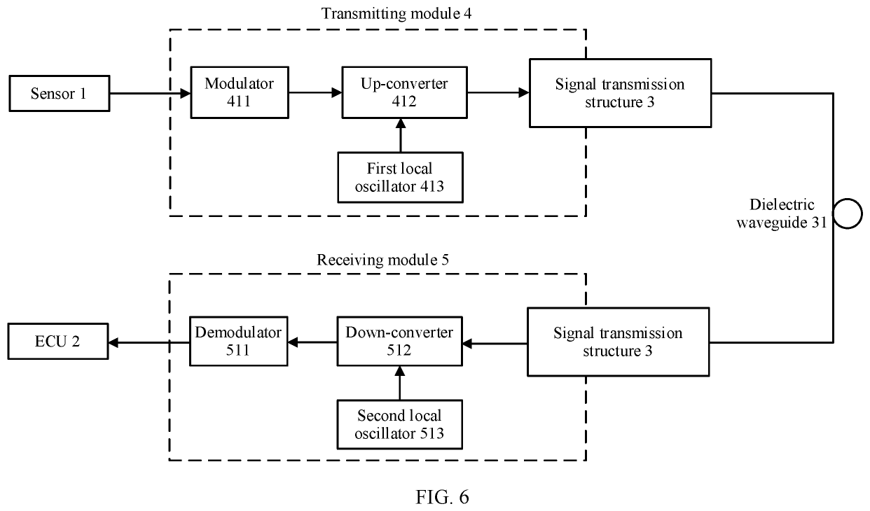

Specifically, the metal waveguide on the first circuit board or the second circuit board may be coupled to and connected to the dielectric waveguide through a connector. In this case, the connector, the metal waveguide, and the dielectric waveguide may form a signal transmission structure between the transmitting module and the receiving module. During specific implementation, as shown in FIG. 6, the transmitting module 4 and the receiving module 5 may be connected by using the foregoing two signal transmission structures 3. A metal waveguide of one signal transmission structure 3 is electrically connected to the transmitting module 4, a metal waveguide of the other signal transmission structure 3 is electrically connected to the receiving module 5, and dielectric waveguides 31 of the two signal transmission structures are also electrically connected. In this way, signal transmission can be implemented between the transmitting module 4 and the receiving module 5. The following describes the signal transmission structure 3 in detail.

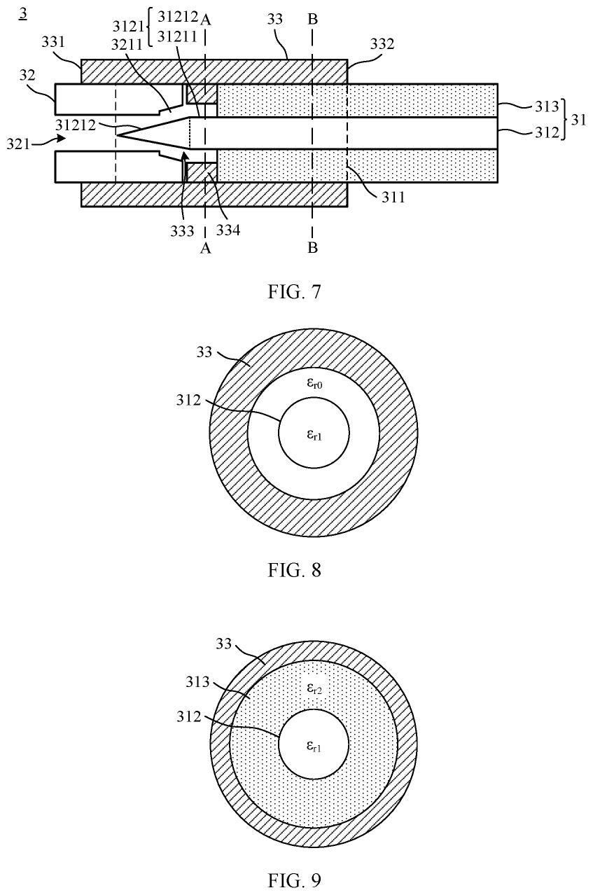

FIG. 7 is a schematic diagram of a structure of a signal transmission structure according to an embodiment of this application. As described above, the signal transmission structure 3 may include the dielectric waveguide 31, the metal waveguide 32, and a connector 33. The connector 33 may include a first end 331 and a second end 332 that are oppositely disposed, and a first through hole 333 that can extend from the first end 331 to the second end 332 of the connector 33 is disposed inside the connector 33. Therefore, the connector 33 is of a hollow tubular structure. The metal waveguide 32 is also roughly of a hollow tubular structure. A second through hole 321 is disposed inside the metal waveguide 32. One end of the metal waveguide 32 may be configured to be connected to a transmitting chip or a receiving chip, and the other end of the metal waveguide 32 may be connected to the first end 331 of the connector 33. After connection is completed, the second through hole 321 of the metal waveguide 32 communicates with the first through hole 333 of the connector 33. The dielectric waveguide 31 is provided with an insertion end 311. The insertion end 311 may be inserted into the first through hole 333 through the second end 332 of the connector 33, and a partial structure of the insertion end 311 may extend into the second through hole 321 of the metal waveguide 32, to implement coupling connection between the metal waveguide 32 and the dielectric waveguide 31.

In this embodiment, the connector 33 may be of a ring-shaped structure, or may be of a rectangular ring, an elliptical ring, or another regular or irregular shape. This is not limited in this application. The first through hole 333 of the connector 33 may have a metal inner wall, to perform impedance matching between the dielectric waveguide 31 and the metal waveguide 32 that are connected to each other, thereby reducing a reflection loss, and improving signal transmission quality. During specific implementation, the connector 33 may be made of an all-metal material, for example, copper, aluminum, stainless steel, and the like. In this case, the first through hole 333 formed through processing in the connector 33 is naturally a through hole having a metal inner wall. In addition, to avoid oxidation of the metal inner wall of the first through hole 333, anti-oxidation processing such as gold plating and silver plating may be performed on the metal inner wall. Alternatively, the connector 33 may be made of a plastic material. In this case, metallization processing such as electroplating may be performed on the inner wall of the first through hole 333, to obtain a metal inner wall. A material of the metal inner wall may be copper, aluminum, or the like. It may be understood that, when the connector 33 is made of the plastic material, after processing is performed on the first through hole 333 to form the metal inner wall, anti-oxidation processing may be subsequently performed on the metal inner wall, to ensure use reliability of the connector 33.

The dielectric waveguide 31 may include a core 312 and a cladding 313 that covers an outer periphery of the core 312. The core 312 may be made of a polymer material, such as polyethene (PE), polytetrafluoroethylene (PTFE), polypropylene (PP), and polystyrene (PS) having a low-loss tangent angle, and the core 312 may also be made of improved materials based on these polymer materials. A loss tangent angle refers to energy consumed by a dielectric by converting electric energy into heat energy per unit volume per unit time, and is a physical quantity representing a dielectric loss of an electrolyte material after an electric field is applied. The cladding 313 may also be made of the foregoing polymer material or a foaming body of the foregoing polymer material. During specific implementation, the cladding 313 may be of a one-layer structure or a multi-layer structure. This is not limited in this application. When the cladding 313 is of the one-layer structure, a relative dielectric constant of the cladding 313 may be less than a relative dielectric constant of the core 312. When the cladding 313 includes two or more layers of layer structures, a relative dielectric constant of at least one layer structure may be less than a relative dielectric constant of the core 312. In this way, electric field energy of a high-frequency signal transmitted in the dielectric waveguide 31 is mainly concentrated in the core 312, and electric field energy distributed in the cladding 313 is less than the electric field energy concentrated in the core 312. Therefore, when the dielectric waveguide 31 is inserted into the connector 33, a metal loss caused by the metal inner wall of the connector 33 may be reduced. In addition, disturbance caused by a metal boundary to an electromagnetic field in the dielectric waveguide 31 may be reduced by disposing the cladding 313, thereby reducing a reflection loss.

In some possible embodiments, the dielectric waveguide 31 may further include a conductor layer (not shown in the figure), and the conductor layer may be wrapped on an outer side of the cladding 313, to perform electromagnetic shielding on the core 312, thereby further improving signal transmission quality. For example, the conductor layer may be specifically made of a metal material, for example, copper, aluminum, stainless steel, or the like.

It should be noted that a cross-sectional shape of the dielectric waveguide 31 may be the same as a cross-sectional shape of the first through hole 333, to ensure that an outer wall of the insertion end 311 of the dielectric waveguide 31 can adhere to the inner wall of the first through hole 333. In addition, after the insertion end 311 of the dielectric waveguide 31 is inserted into the first through hole 333, uniform and symmetrical external force may be applied to a position that is on the connector 33 and that corresponds to on an outer peripheral side of the insertion end 311, so that the dielectric waveguide 31 can be reliably assembled in the connector 33.

The core 312 may have an extension segment 3121 extending out of the cladding 313 at the insertion end 311 of the dielectric waveguide 31. The extension segment 3121 may partially or completely extend into the second through hole 321 of the metal waveguide 32, and is spaced from an inner wall of the second through hole 321. A cross-sectional area of an end part of the extension segment 3121 may gradually decrease in a direction from the second end 332 to the first end 331 of the connector 33. In some embodiments, the entire extension segment 3121 may be of a conical structure. In some other embodiments, the extension segment 3121 may include a uniform segment 31211 and a gradient segment 31212 that are sequentially disposed away from an end part of the cladding 313, a cross-sectional area of the uniform segment 31211 may remain unchanged in an axial direction, and the gradient segment 31212 may be of a conical structure. In a process in which a shape of the extension segment 3121 gradually changes, electric field energy on the dielectric waveguide 31 is gradually concentrated to the end part of the extension segment 3121, and then gradually coupled to the metal waveguide 32 at the end part of the extension segment 3121. In this way, signal transfer is implemented between the dielectric waveguide 31 and the metal waveguide 32.

In some embodiments, the metal waveguide 32 may be made of an all-metal material. For example, a material of the metal waveguide 32 includes but is not limited to copper, aluminum, stainless steel, and the like. In this case, the inner wall of the second through hole 321 is naturally a metal inner wall. In some other embodiments, the metal waveguide 32 may alternatively be a plastic structure with a metalized inner wall. During specific implementation, a metallization layer may be formed on the inner wall of the second through hole 321 by using an electroplating process, and a material of the metallization layer may be specifically copper, aluminum, or the like, and a thickness of the metallization layer may not be less than a skin depth of a to-be-transmitted high-frequency signal at an operating frequency of the to-be-transmitted high-frequency signal, to ensure integrity of signal transmission. A skin depth may be understood as that when a current with a high frequency passes through a conducting wire, it may be considered that the current flows through only an excessively thin layer on a surface of the conducting wire. Therefore, a hollow conducting wire may be used in a high-frequency circuit instead of a solid conducting wire. In this case, a thickness of the conducting wire is the skin depth.

The metal waveguide 32 may be of a ring-shaped structure, or may be of a rectangular ring, an elliptical ring, or another regular or irregular shape. This is not limited in this application. A ring-shaped metal waveguide 32 is used as an example. According to a basic theory of an inner diameter of the metal waveguide 32, a cut-off frequency of a dominant mode TE11 mode of the metal waveguide 32 should be lower than a lowest frequency in an operating frequency band of a to-be-transmitted signal. In addition, the second through hole 321 may include a first hole segment 3211 disposed close to one end of the connector 33, and an inner diameter of the first hole segment 3211 may gradually increase in a direction from the first end 331 to the second end 332 of the connector 33. In other words, one end that is of the second through hole 321 and that is close to the connector 33 may be of a flared structure. During specific implementation, the inner diameter of the first hole segment 3211 may increase linearly and evenly, may gradually increase in a stepped shape, or may use another design form, provided that a trend of gradually increasing can be implemented. This is not limited in this application. In FIG. 7, that the inner diameter of the first hole segment 3211 increases linearly and evenly is used as an example for description. In a specific design, a length of the first hole segment 3211 may not be less than λₒ, where λₒ is a free space wavelength of an operating frequency of a to-be-transmitted signal, and a value of the operating frequency may be a center frequency in an operating frequency band of the to-be-transmitted signal. In this case, λₒ is a speed of light/center frequency.

When the signal transmission structure 3 is assembled, the end part of the extension segment 3121 of the dielectric waveguide 31 may be inserted into the second through hole 321. Specifically, when the entire dielectric waveguide 31 is of the conical structure, the entire extension segment 3121 or a part of the end part of the extension segment 3121 may be inserted into the second through hole 321. When the dielectric waveguide 31 includes the uniform segment 31211 and the gradient segment 31212, a part of the end part of the gradient segment 31212 may be inserted into the second through hole 321, the entire gradient segment 31212 may be inserted into the second through hole 321, or a part of the uniform segment 31211 may be inserted into the second through hole 321. This is not specifically limited in this application. In this design, a flared structure of the first hole segment 3211 may match a conical structure of the extension segment 3121, to avoid a sudden change of transmission impedance in a process in which signal energy on the dielectric waveguide 31 is coupled to the metal waveguide 32, thereby ensuring a matching degree of assembly of the connector 33.

Still refer to FIG. 7. In some embodiments, an end part of the metal waveguide 32 may extend out of an outer side of a circuit board of the transmitting module or the receiving module, and is inserted into the first through hole 333 through the first end 331 of the connector 33. In this case, a cross-sectional shape of an outer wall of the metal waveguide 32 may be the same as a cross-sectional shape of the first through hole 333, to ensure that the outer wall of the metal waveguide 32 can adhere to the inner wall of the first through hole 333. Similarly, after the end part of the metal waveguide 32 is inserted into the first through hole 333, uniform and symmetrical external force may be applied to a position that is on the connector 33 and that corresponds to an outer peripheral side of the end part of the metal waveguide 32, so that the metal waveguide 32 can be reliably assembled in the connector 33.

In a specific embodiment, a protrusion 334 may be disposed on the inner wall of the first through hole 333, and at the insertion end 311 of the dielectric waveguide 31, the end part of the cladding 313 may be in contact with a side that is of the protrusion 334 and that faces the second end 332 of the connector 33. In this way, positioning of the insertion end 311 of the dielectric waveguide 31 may be implemented by using the protrusion 334, to ensure that the dielectric waveguide 31 is properly inserted. The extension segment 3121 of the core 312 may pass through the protrusion 334 and extend in a direction toward the first end 331 of the connector 33, and a peripheral side of the extension segment 3121 is spaced from a surface of the protrusion 334. Similarly, the end part of the metal waveguide 32 may be in contact with a side that is of the protrusion 334 and that faces the first end 331 of the connector 33. In this way, positioning of the metal waveguide 32 may be implemented by using the protrusion 334, to ensure that the metal waveguide 32 is properly inserted. It should be noted that, at the end part of the metal waveguide 32, an inner diameter of the second through hole 321 may be approximately equal to an inner diameter of the protrusion 334, and a difference between the inner diameter of the second through hole 321 and the inner diameter of the protrusion 334 is allowed, provided that the difference falls within an allowed error range. This helps increase a matching degree of assembly of the connector 33. In addition, during specific arrangement, the protrusion 334 may also have a metal surface, to perform impedance matching between the dielectric waveguide 31 and the metal waveguide 32 that are connected to each other, thereby reducing a reflection loss, and improving signal transmission quality.

In the foregoing embodiment, in a specific design, the protrusion 334 may be an independent component. In this case, the protrusion 334 and the connector 33 may be separately processed, and then assembled and fastened in the first through hole 333. Alternatively, the protrusion 334 and the connector 33 may be of an integrated structure. In this way, a subsequent assembly step may be omitted, thereby simplifying an assembly process of the entire signal transmission structure 3. Certainly, in some other implementations, the protrusion 334 and the metal waveguide 32 may be of an integrated structure. In this case, the protrusion 334 may be considered as a segment of positioning structure extending from the end part of the metal waveguide 32. A specific disposing manner of the protrusion is not limited in this application, provided that positioning of the metal waveguide 32 and the dielectric waveguide 31 can be implemented in the first through hole 333.

For example, the protrusion 334 may be of a ring-shaped structure. In this way, positioning of the dielectric waveguide 31 and the metal waveguide 32 that are located on both sides of the protrusion 334 may be implemented in an entire circumferential direction, thereby further improving assembly precision of the entire signal transmission structure 3.

In some other embodiments, there may alternatively be a gap between the end part of the metal waveguide 32 and the protrusion 334 facing the first end 331 of the connector 33. Because energy of a signal transmitted in the dielectric waveguide 31 is mainly concentrated in the core 312, and the extension segment 3121 of the core 312 may extend into the second through hole 321 of the metal waveguide 32, even if there is a gap between the end part of the metal waveguide 32 and the protrusion 334, less energy is leaked on the dielectric waveguide 31, and impact on quality of the transmitted signal is small.

FIG. 8 is a schematic diagram of a cross-sectional structure at A-A in FIG. 7, and FIG. 9 is a schematic diagram of a cross-sectional structure at B-B in FIG. 7. Refer to FIG. 7, FIG. 8, and FIG. 9. The signal transmission structure 3 may have a first cross section and a second cross section, and the first cross section may be located between the end part of the cladding 313 at the insertion end 311 and the end part of the extension segment 3121. It should be noted that, when the extension segment 3121 includes the uniform segment 31211 and the gradient segment 31212, a first plane is defined as a plane closer to the first end 331 of the connector 33 in a plane in which an end of the uniform segment 31211 is connected to the gradient segment 31212 is located and a plane in which the side that is of the protrusion 334 and that faces the first end 331 of the connector 33 is located. For example, in the embodiment shown in FIG. 7, the first plane is a plane in which the side that is of the protrusion 334 and that faces the first end 331 of the connector 33 is located. In this case, the first cross section may be specifically located between the end part of the cladding 313 and the first plane. As shown in FIG. 8, a cross section A-A is used as an example for description. The second cross section may be located between the second end 332 of the connector 33 and the end part of the cladding 313 at the insertion end 311, for example, a cross section B-B shown in FIG. 9.

The following uses an example in which the connector 33 is of a ring-shaped structure, and a concept of an equivalent dielectric constant ε_{eff} is introduced to analyze a matching characteristic of two segments of structures. The equivalent dielectric constant ε_{eff} may be understood as that a waveguide is equivalently filled with a uniform substance whose dielectric constant is ε_{eff}.

An equivalent dielectric constant ε_{eff1} at the first cross section A-A may be represented as:

$$\\ {ε}_{eff 1} = \frac{{S}_{1} {ε}_{r 1} + ( {S}_{0} - {S}_{1} ) {ε}_{r 0}}{{S}_{0}} .$$

εᵣₒ is a relative dielectric constant of air, εᵣ₁ is a relative dielectric constant of the core 312 of the dielectric waveguide 31, S₁ is a cross-sectional area of the core 312 at the first cross section A-A,

$$\\ {S}_{1} = {π ( {d}_{1} / 2 )}^{2} ,$$

d₁ is a diameter of the core 312 at the first cross section A-A, Sₒ is a cross-sectional area of a hole-shaped structure at the first cross section A-A, for example, FIG. 8 shows a cross-sectional area of an inner hole formed by the ring-shaped protrusion 334,

$$\\ {S}_{0} = {π ( {d}_{0} / 2 )}^{2} ,$$

and dₒ is an inner diameter of a hole-shaped structure at the first cross section A-A.

An equivalent dielectric constant ε_{eff2} at the second cross section B-B may be represented as:

$$\\ {ε}_{eff 2} = \frac{{S}_{1} {ε}_{r 1} + ( {S}_{2} - {S}_{1} ) {ε}_{r 2}}{{S}_{2}} .$$

εᵣ₂ is a relative dielectric constant of the cladding 313 of the dielectric waveguide 31, S₂ is a cross-sectional area of the dielectric waveguide 31 at the second cross section B-B,

$$\\ {S}_{2} = {π ( {d}_{2} / 2 )}^{2} ,$$

and d₂ is an outer diameter of the cladding 313 of the dielectric waveguide 31.

According to simulation and experiment, the connector can work properly when ε_{eff1} and ε_{eff2} satisfy the following tolerance relationship:

$$\\ \frac{\vert {ε}_{eff 2} - {ε}_{eff 1} \vert}{{ε}_{eff 2}} \times 100 \% \leq 20 \% .$$

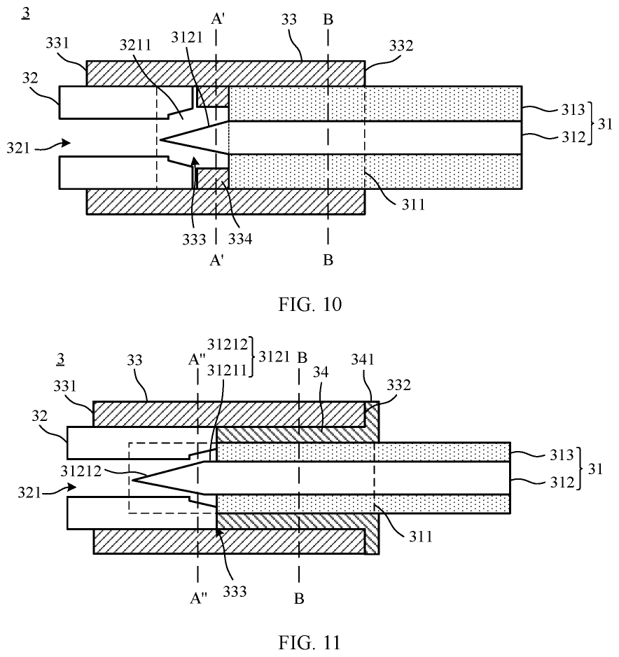

FIG. 10 is a schematic diagram of a structure of another signal transmission structure according to an embodiment of this application. Refer to FIG. 10. When the entire extension segment 3121 is of a conical structure, the first cross section may be specifically located between the end part of the cladding 313 and the side that is of the protrusion and that faces the first end 331 of the connector 33. In FIG. 10, a cross section A′-A′ is used as an example for description. It may be understood that a diameter of the core 312 at A′-A′ is a diameter of the conical structure at the cross section, and an inner diameter of a hole structure at A′-A′ is an inner diameter of the protrusion 334. In this case, an equivalent dielectric constant ε_{eff1} at the first cross section A′-A′ and the equivalent dielectric constant ε_{eff2} at the second cross section B-B may also be limited by using a relationship in the foregoing embodiment, to ensure an impedance matching state of the signal transmission structure in an assembly process.

FIG. 11 is a schematic diagram of a structure of another signal transmission structure according to an embodiment of this application. Refer to FIG. 11. In this embodiment, the signal transmission structure 3 may further include a sleeve 34, the insertion end 311 of the dielectric waveguide 31 may be fastened in the sleeve 34, and the end part of the cladding 313 at the insertion end 311 may be flush with an end part of the sleeve 34. A first limiting step 341 is disposed on an outer wall of the sleeve 34, the sleeve 34 may be inserted into the first through hole 333 through the second end 332 of the connector 33, and the first limiting step 341 may abut against the second end 332 of the connector 33, thereby implementing positioning of the sleeve 34 on the connector 33, and further implementing positioning of the insertion end 311 of the dielectric waveguide 31 in the connector 33. In this case, when the metal waveguide 32 is inserted into the first through hole 333, the end part of the metal waveguide 32 may abut against the end part of the sleeve 34. In this way, positioning of the metal waveguide 32 may be implemented by using the sleeve 34, to ensure that the metal waveguide 32 is properly inserted. That is, in this embodiment, the protrusion does not need to be disposed on the inner wall of the first through hole 333. Instead, positioning of the dielectric waveguide 31 and the metal waveguide 32 in the connector 33 may be implemented by adding the sleeve 34.

During specific implementation, the sleeve 34 may be of an all-metal structure, or may be of a plastic structure with a metalized inner wall. This is not limited in this application. In addition, a cross-sectional shape of the outer wall of the sleeve 34 may be the same as a cross-sectional shape of the first through hole 333, to ensure that the outer wall of the sleeve 34 can adhere to the inner wall of the first through hole 333, thereby improving assembly reliability of the sleeve 34 and the connector 33.

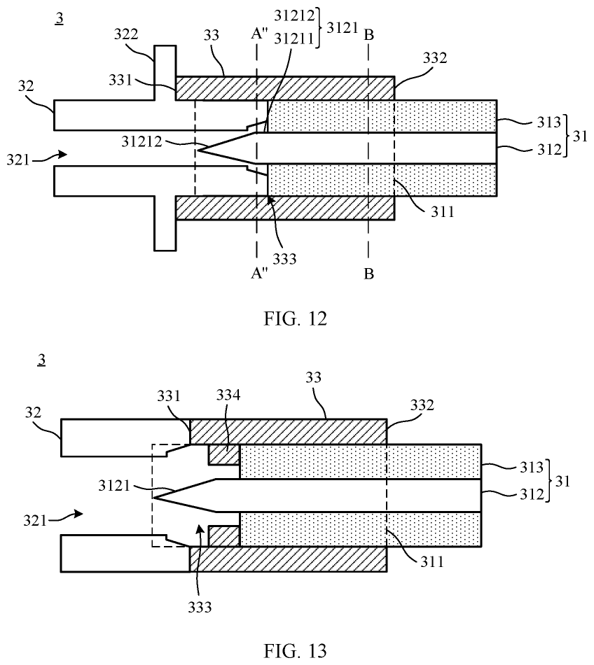

FIG. 12 is a schematic diagram of a structure of another signal transmission structure according to an embodiment of this application. Refer to FIG. 12. In this embodiment, a second limiting step 322 may be disposed on an outer wall of the metal waveguide 32, and when the metal waveguide 32 is inserted into the first through hole 333, the second limiting step 322 may abut against the first end 331 of the connector 33. In this way, positioning of the metal waveguide 32 in the connector 33 may be implemented. In the first through hole 333, the end part of the cladding 313 at the insertion end 311 of the dielectric waveguide 31 may abut against the end part of the metal waveguide 32. In this way, positioning of the dielectric waveguide 31 may be implemented by using the metal waveguide 32, to ensure that the dielectric waveguide 31 is properly inserted. Similarly, in this embodiment, the protrusion does not need to be disposed on the inner wall of the first through hole 333. Instead, positioning of the dielectric waveguide 31 and the metal waveguide 32 in the connector 33 may be implemented by improving a structure of the metal waveguide 32.

It should be noted that, in the embodiments shown in FIG. 11 and FIG. 12, when the extension segment includes the uniform segment 31211 and the gradient segment 31212, a second plane is defined as a plane closer to the first end 331 of the connector 33 in a plane in which an end of the uniform segment 31211 is connected to the gradient segment 31212 is located and a plane in which an end part that is of the first hole segment 3211 and that is close to the first end 331 of the connector 33 is located. For example, in FIG. 11 and FIG. 12, the second plane is a plane in which the end part that is of the first hole segment 3211 and that is close to the first end 331 of the connector 33 is located. In this case, the first cross section may be specifically located between the end part of the cladding 313 and the second plane. In FIG. 11 and FIG. 12, a cross section A″-A″ is used as an example for description. An equivalent dielectric constant ε_{eff1} at the first cross section A″-A″ of the signal transmission structure 3 and an equivalent dielectric constant ε_{eff2} at the second cross section B-B of the signal transmission structure 3 may also be limited by using a relationship in the foregoing embodiment. Details are not described herein again.

In addition, when the entire extension segment 3121 is of a conical structure, the first cross section may be specifically located between two ends of the first hole segment 3211. In this case, an equivalent dielectric constant ε_{eff1} at the first cross section and an equivalent dielectric constant ε_{eff2} at the second cross section may also be limited by using a relationship in the foregoing embodiment.

FIG. 13 is a schematic diagram of a structure of another signal transmission structure according to an embodiment of this application. Refer to FIG. 13. In some embodiments, the metal waveguide 32 may also be directly interconnected to the first end 331 of the connector 33, and the metal waveguide 32 does not need to be inserted into the first through hole 333. In this case, the metal waveguide 32 may be completely located on a circuit board of a transmitting module or a receiving module, or the end part of the metal waveguide 32 may extend out of the circuit board. This is not limited in this application. During specific implementation, the end part of the metal waveguide 32 and the first end 331 of the connector 33 may be relatively fastened by using a connecting apparatus such as a fastener, a buckle, or a flange.

In addition, in this embodiment, an equivalent dielectric constant ε_{eff1} at the first cross section of the signal transmission structure 3 and an equivalent dielectric constant ε_{eff2} at the second cross section of the signal transmission structure 3 may also be limited by using a relationship in the foregoing embodiment. Details are not described herein again.

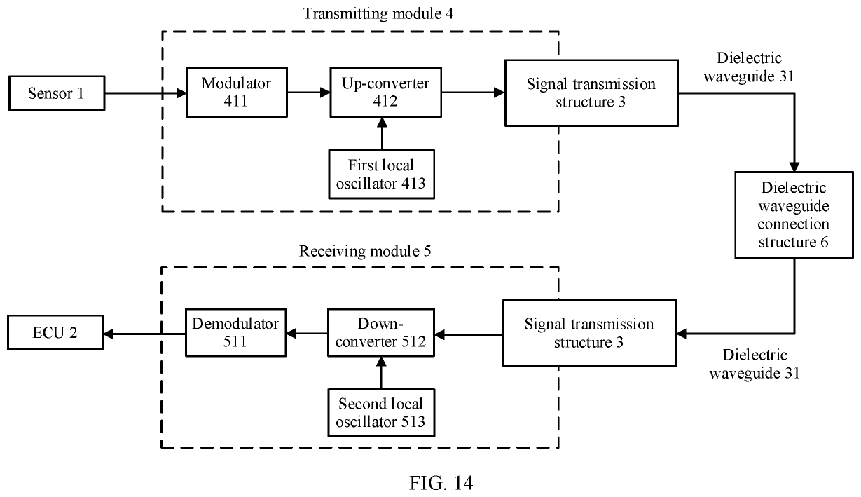

FIG. 14 is a schematic diagram of another signal transmission path between a vehicle sensor and an ECU according to an embodiment of this application. As described above, the transmitting module 4 and the receiving module 5 may be connected by using the foregoing two signal transmission structures 3. A metal waveguide of one signal transmission structure 3 is electrically connected to the transmitting module 4, a metal waveguide of the other signal transmission structure 3 is electrically connected to the receiving module 5, and dielectric waveguides 31 of the two signal transmission structures are also electrically connected. During specific implementation, the dielectric waveguides 31 of the two signal transmission structures 3 may be of an integrated structure, or may be of a split structure. This is not limited in this application. When the dielectric waveguides 31 of the two signal transmission structures 3 are of the split structure, to ensure smooth communication between the transmitting module 4 and the receiving module 5, an embodiment of this application further provides a dielectric waveguide connection structure 6, and end parts of the two dielectric waveguides 31 may be electrically connected by using the dielectric waveguide connection structure 6. It should be noted that, in addition to being configured to connect the two split dielectric waveguides 31, the dielectric waveguide connection structure 6 provided in this embodiment of this application may further be configured to reconnect a damaged (for example, disconnected) integrated dielectric waveguide 31, to ensure uninterrupted signal transmission between the transmitting module 4 and the receiving module 5 that are connected to two ends of the dielectric waveguide 31. The following describes the dielectric waveguide connection structure 6 in detail.

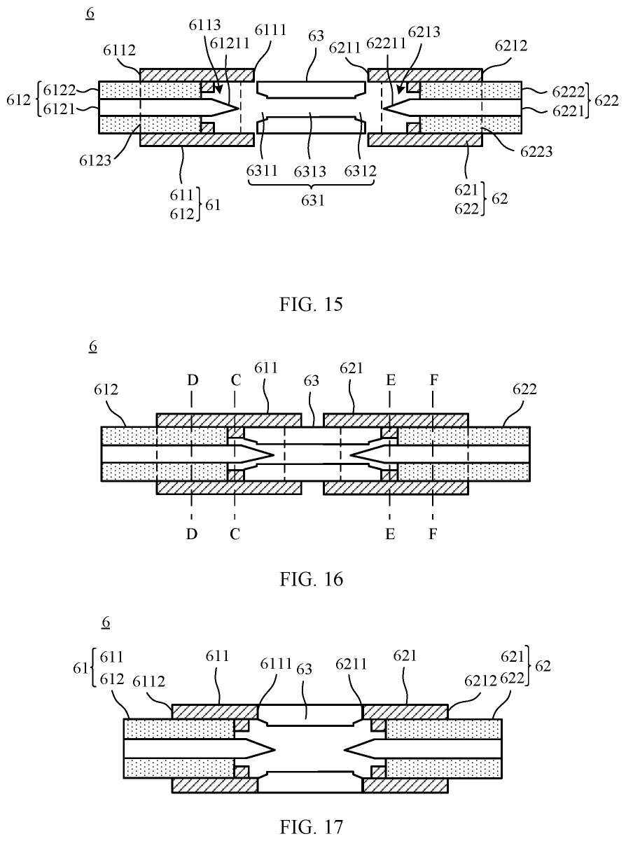

Refer to FIG. 15 and FIG. 16. FIG. 15 is an exploded schematic diagram of a dielectric waveguide connection structure according to an embodiment of this application. FIG. 16 is a schematic diagram of a structure of the dielectric waveguide connection structure shown in FIG. 15. In this embodiment of this application, the dielectric waveguide connection structure 6 may include a first connector assembly 61, a second connector assembly 62, and a first metal waveguide 63. Each connector assembly may include a first connector 611 and a first dielectric waveguide 612. The first connector assembly 61 is used as an example for description. The first connector 611 may include a first end 6111 and a second end 6112 that are oppositely disposed. A first through hole 6113 extending from the first end 6111 to the second end 6112 of the first connector 611 is disposed inside the first connector 611. The first dielectric waveguide 612 includes a first core 6121 and a first cladding 6122 that covers an outer periphery of the first core 6121, and the first dielectric waveguide 612 is provided with an insertion end 6123. The insertion end 6123 may be inserted into the first through hole 6113 through the second end 6112 of the connector 611. A second through hole 631 is disposed inside the first metal waveguide 63, one end of the first metal waveguide 63 may be connected to the first end 6111 of the first connector 611 of the first connector assembly 61, and the other end of the first metal waveguide 63 may be connected to a first end 6211 of a first connector 621 of the second connector assembly 62. After connection is completed, the second through hole 631 of the first metal waveguide 63 may separately communicate with first through holes 6113 and 6213 of the first connectors 611 and 621 on both sides of the first metal waveguide 63. The insertion end 6123 of the first dielectric waveguide 612 of the first connector assembly 61 may be inserted into the second through hole 631 through a left end of the first metal waveguide 63, and an insertion end 6223 of a first dielectric waveguide 622 of the second connector assembly 62 may be inserted into the second through hole 631 through a right end of the first metal waveguide 63, to implement coupling connection between the first metal waveguide 63 and first dielectric waveguides 612 and 622 on both sides of the first metal waveguide 63. It may be understood that the first dielectric waveguide 612 of the first connector assembly 61 and the first dielectric waveguide 622 of the second connector assembly 62 are two dielectric waveguides that need to be connected.

During specific implementation, for structural forms of the first connector 611 and the first dielectric waveguide 612, refer to a manner of setting a connector and a dielectric waveguide in the foregoing embodiment of the signal transmission structure. Details are not described herein again. The extension segment 61211 of the first core 6121 of the left first dielectric waveguide 612 may completely or partially extend from the left end of the first metal waveguide 63 into the second through hole 631. An end part of an extension segment 62211 of a first core 6221 of the right first dielectric waveguide 622 may completely or partially extend from the right end of the first metal waveguide 63 into the second through hole 631. When a signal is transmitted from the first connector assembly 61 to the second connector assembly 62, electric field energy on the first dielectric waveguide 612 of the first connector assembly 61 is concentrated at an end part of the extension segment 61211 of the first connector assembly 61, then is gradually coupled to the first metal waveguide 63 from the end part of the extension segment 61211, propagates in a direction from the left end to the right end of the first metal waveguide 63, and then is gradually coupled to the extension segment 62211 of the first dielectric waveguide 622 of the second connector assembly 62 from the right end of the first metal waveguide 63. In this way, signal transfer is implemented between the two first dielectric waveguides 612 and 622.

The second through hole 631 of the first metal waveguide 63 may include a first hole segment 6311, a second hole segment 6312, and a third hole segment 6313. The first hole segment 6311 is disposed close to the first connector assembly 61, the second hole segment 6312 is disposed close to the second connector assembly 62, and the third hole segment 6313 is connected between the first hole segment 6311 and the second hole segment 6312. An inner diameter of the first hole segment 6311 may gradually increase in a direction from the third hole segment 6313 to the first connector assembly 61, and similarly, an inner diameter of the second hole segment 6312 may also gradually increase in a direction from the third hole segment 6313 to the second connector assembly 62. An inner diameter of the third hole segment 6313 remains roughly unchanged. In other words, two ends of the second through hole 631 each are of a flared structure. In a specific design, a length of each of the first hole segment 6311, the second hole segment 6312, and the third hole segment 6313 may not be less than λₒ, where λₒ is a free space wavelength of an operating frequency of a to-be-transmitted signal.

Still refer to FIG. 15 and FIG. 16. In some embodiments, two ends of the first metal waveguide 63 may be respectively inserted into first through holes 6113 and 6213 of first connectors 611 and 621 on both sides of the first metal waveguide 63. In this case, a cross-sectional shape of an outer wall of the first metal waveguide 63 may be the same as cross-sectional shapes of the first through holes 6113 and 6213 of the first connectors 611 and 621 on both sides of the first metal waveguide 63, to ensure that the outer wall of the first metal waveguide 63 can adhere to inner walls of the first through holes 6113 and 6213.

The first connector assembly 61 may have a first cross section and a second cross section. The first cross section may be located between the end part of the cladding 6122 at the insertion end 6123 and the end part of the extension segment 61211, and a cross section C-C in FIG. 16 is used as an example for description. The second cross section may be located between the second end 6112 of the first connector 611 and the end part of the cladding 6122 at the insertion end 6123, for example, a cross section D-D shown in FIG. 16. Calculation methods of an equivalent dielectric constant ε_{eff1} at the first cross section C-C and an equivalent dielectric constant ε_{eff2} at the second cross section D-D are the same as calculation methods in the foregoing embodiment of the signal transmission structure, and are not repeated herein. When the equivalent dielectric constant ε_{eff1} at the first cross section C-C and the equivalent dielectric constant ε_{eff2} at the second cross section D-D satisfy the following tolerance relationship, the first connector 611 of the first connector assembly can work normally:

$$\\ \frac{\vert {ε}_{eff 2} - {ε}_{eff 1} \vert}{{ε}_{eff 2}} \times 100 \% \leq 20 \% .$$

Similarly, an equivalent dielectric constant at a first cross section E-E of the second connector assembly 62 and an equivalent dielectric constant at a second cross section F-F of the second connector assembly 62 may also be limited by using the foregoing relationship, to ensure that the first connector 621 of the second connector assembly 62 can work normally. Details are not described herein again.

FIG. 17 is a schematic diagram of a structure of another dielectric waveguide connection structure according to an embodiment of this application. Refer to FIG. 17. In this embodiment, a left end of the first metal waveguide 63 may be directly interconnected to the first end 6111 of the left first connector 611, and similarly, a right end of the first metal waveguide 63 may also be directly interconnected to the first end 6211 of the right first connector 621. During specific implementation, two ends of the first metal waveguide 63 may be fixedly connected to the first connectors 611 and 621 on both sides of the first metal waveguide 63 by using connecting apparatuses such as fasteners, buckles, or flanges.

It should be noted that, in the embodiment shown in FIG. 16, an equivalent dielectric constant at a first cross section of the first connector assembly 61 and an equivalent dielectric constant at a second cross section of the first connector assembly 61 may also be limited by using a relationship in the foregoing embodiment, and an equivalent dielectric constant at a first cross section of the second connector assembly 62 and an equivalent dielectric constant at a second cross section of the second connector assembly 62 may also be limited by using a relationship in the foregoing embodiment. Details are not described herein again.

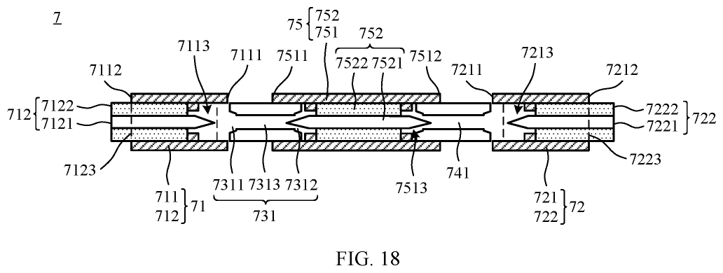

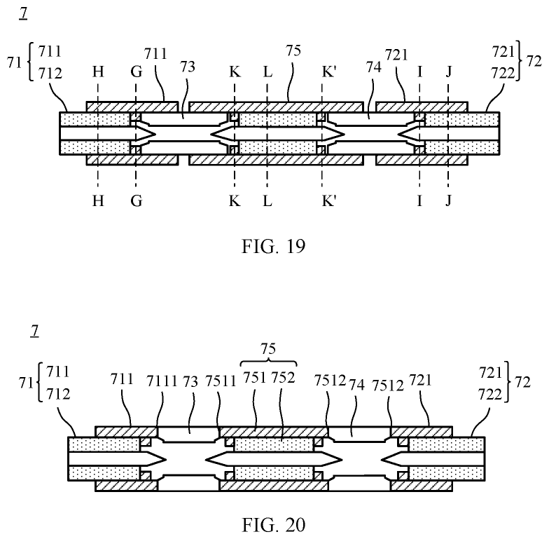

Refer to FIG. 18 and FIG. 19. FIG. 18 is a partially exploded schematic diagram of another dielectric waveguide connection structure according to an embodiment of this application. FIG. 19 is a schematic diagram of a structure of the dielectric waveguide connection structure shown in FIG. 18. In this embodiment of this application, a dielectric waveguide connection structure 70 may include a first connector assembly 71, a second connector assembly 72, a first metal waveguide 73, a second metal waveguide 74, and an intermediate connection assembly 75. Each connector assembly may include a first connector 711 and a first dielectric waveguide 712. The first connector assembly 71 is used as an example for description. The first connector 711 may include a first end 7111 and a second end 7112 that are oppositely disposed. A first through hole 7113 extending from the first end 7111 to the second end 7112 of the first connector 611 is disposed inside the first connector 611. The first dielectric waveguide 712 includes a first core 7121 and a first cladding 7122 that covers an outer periphery of the first core 7121, and the first dielectric waveguide 712 is provided with an insertion end 7123. The insertion end 7123 may be inserted into the first through hole 7113 through the second end 7112 of the first connector 711. The first metal waveguide 73 may have a second through hole 731, and the second metal waveguide 74 may have a second through hole 741. The intermediate connection assembly 75 may include a second connector 751 and a second dielectric waveguide 752. The second connector 751 includes a first connection end 7511 and a second connection end 7512 that are oppositely disposed. A third through hole 7513 extending from the first connection end 7511 to the second connection end 7512 is disposed inside the second connector 751. The second dielectric waveguide 752 is disposed in the third through hole 7513. The second dielectric waveguide 752 includes a second core 7521 and a second cladding 7522 that covers an outer periphery of the second core 7521. Two ends of the second core 7521 may separately exceed the second cladding 7522.

One end of the first metal waveguide 73 may be connected to the first end 7111 of the first connector 711 of the first connector assembly 71, and the other end of the first metal waveguide 73 may be connected to the first connection end 7511 of the second connector 751. After connection is completed, the second through hole 731 of the first metal waveguide 73 may separately communicate with the first through hole 7113 of the first connector 711 and the third through hole 7513 of the second connector 751. The insertion end 7123 of the first dielectric waveguide 712 of the first connector assembly 71 may be inserted into the second through hole 731 through a left end of the first metal waveguide 73. One end that is of the second core 7521 and that is close to the first connection end 7511 may be inserted into the second through hole 731 through a right end of the first metal waveguide 73. One end of the second metal waveguide 74 may be connected to a first end 7211 of a first connector 721 of the second connector assembly 72, and the other end of the second metal waveguide 74 may be connected to the second connection end 7512 of the second connector 751. After connection is completed, the second through hole 741 of the second metal waveguide 74 may separately communicate with a first through hole 7213 of the first connector 721 and the third through hole 7513 of the second connector 751. An insertion end 7223 of a first dielectric waveguide 722 of the second connector assembly 72 may be inserted into the second through hole 741 from a right end of the second metal waveguide 74. An end that is of the second core 7521 and that is close to the second connection end 7512 may be inserted into the second through hole 741 through a left end of the second metal waveguide 74. In this way, the first metal waveguide 73, the second metal waveguide 74, and the intermediate connection assembly 75 may be used to implement coupling connection between first dielectric waveguides 712 and 722 on both sides of the intermediate connection assembly 75. It may be understood that the first dielectric waveguide 712 of the first connector assembly 71 and the first dielectric waveguide 722 of the second connector assembly 72 are two dielectric waveguides that need to be connected.

During specific implementation, for structural forms of the first connector 711 and the first dielectric waveguide 712, refer to a manner of setting a connector and a dielectric waveguide in the foregoing embodiment of the signal transmission structure. Details are not described herein again. Two ends that are of the second core 7521 of the second dielectric waveguide 752 and that exceed the second cladding 7522 may also be of gradient structures. For example, the two ends of the second core 7521 may be of conical structures. An end part of the extension segment of the first core 7121 of the left first dielectric waveguide 712 may partially or completely extend from the left end of the first metal waveguide 73 into the second through hole 731 of the first metal waveguide 73. An end part of an extension segment of a first core 7221 of the right first dielectric waveguide 722 may partially or completely extend from the right end of the second metal waveguide 74 into the second through hole 741 of the second metal waveguide 74. In addition, a left end of the second core 7521 may extend from the right end of the first metal waveguide 73 to the second through hole 731 of the first metal waveguide 73, and a right end of the second core 7521 may extend from the left end of the second metal waveguide 74 to the second through hole 741 of the second metal waveguide 74. When a signal is transmitted from the first connector assembly 71 to the second connector assembly 72, electric field energy on the first dielectric waveguide 712 of the first connector assembly 71 is gradually concentrated to the end part of the extension segment of the first dielectric waveguide 712, then is gradually coupled to the first metal waveguide 73 from the end part of the extension segment, propagates in a direction from the left end to the right end of the first metal waveguide 73, then is gradually coupled to the left end of the second dielectric waveguide 752 from the right end of the first metal waveguide 73, then is coupled to the second metal waveguide 74 from the right end of the second dielectric waveguide 752, propagates in a direction from the left end to the right end of the second metal waveguide 74, and finally is gradually coupled to the extension segment of the first dielectric waveguide 722 of the second connection assembly 72 from the right end of the second metal waveguide 74. In this way, signal transfer is implemented between two first dielectric waveguides 712 and 722.

The second through hole 731 of the first metal waveguide 73 may include a first hole segment 7311, a second hole segment 7312, and a third hole segment 7313. The first hole segment 7311 is disposed away from the intermediate connection assembly 75, the second hole segment 7312 is disposed close to the intermediate connection assembly 75, and the third hole segment 7313 is connected between the first hole segment 7311 and the second hole segment 7312. In a direction away from the third hole segment 7313, an inner diameter of the first hole segment 7311 and an inner diameter of the second hole segment 7312 may gradually increase, and an inner diameter of the third hole segment 7313 remains roughly unchanged. In other words, two ends of the second through hole 731 of the first metal waveguide 73 may be of flared structures. In a specific design, a length of each of the first hole segment 7311, the second hole segment 7312, and the third hole segment 7313 may not be less than λₒ, where λₒ is a free space wavelength of an operating frequency of a to-be-transmitted signal. Similarly, the second through hole 741 of the second metal waveguide 74 may also be designed in the foregoing manner. Details are not described herein again.

Refer to FIG. 18 and FIG. 19. In some embodiments, a left end of the first metal waveguide 73 may be inserted into the first through hole 7113 of the left first connector 711, and a right end of the first metal waveguide 73 may be inserted into the third through hole 7513 of the second connector 751. Similarly, a left end of the second metal waveguide 74 may be inserted into the third through hole 7513 of the second connector 751, and a right end of the second metal waveguide 74 may be inserted into the first through hole 7213 of the right first connector 721.

In addition, the first connector assembly 71 may have a first cross section and a second cross section. The first cross section may be located between the end part of the cladding 7122 at the insertion end 7123 and the end part of the extension segment, and a cross section G-G in FIG. 19 is used as an example for description. The second cross section may be located between the second end 7112 of the first connector 711 and the end part of the cladding 7122 at the insertion end 7123, for example, a cross section H-H shown in FIG. 19. Similarly, the second connector assembly 72 may have a first cross section I-I and a second cross section J-J. In specific implementation, an equivalent dielectric constant at the first cross section G-G of the first connector assembly 71, an equivalent dielectric constant at the second cross section H-H of the first connector assembly 71, an equivalent dielectric constant at the first cross section I-I of the second connector assembly 72, and an equivalent dielectric constant at the second cross section J-J of the second connector assembly 72 may be limited by using a relation in the foregoing embodiment, to ensure that the first connector assembly 71 and the second connector assembly 72 can work normally.

It may be understood that the intermediate connection assembly 75 may also have a first cross section and a second cross section. The first cross section may be located between a left end of the second cladding 7522 and a left end of the second core 7521, or may be located between a right end of the second cladding 7522 and a right end of the second core 7521, for example, a cross section K-K or a cross section K′-K′ shown in FIG. 15. The second cross section may be located between the left and right ends of the second cladding 7522, for example, a cross section L-L shown in 15. During specific implementation, an equivalent dielectric constant at the first cross section of the intermediate connection assembly 75 and an equivalent dielectric constant at the second cross section of the intermediate connection assembly 75 may also be limited by using a relation in the foregoing embodiment, to ensure that the intermediate connection assembly 75 can work normally.

FIG. 20 is a schematic diagram of a structure of another dielectric waveguide connection structure according to an embodiment of this application. Refer to FIG. 20. In this embodiment, a left end of the first metal waveguide 73 may be directly interconnected to the first end 7111 of the left first connector 711, and a right end of the first metal waveguide 73 may be directly interconnected to the first connection end 7511 of the second connector 751. Similarly, a left end of the second metal waveguide 74 may be directly interconnected to the second connection end 7512 of the second connector 751, and a right end of the second metal waveguide 74 may be directly interconnected to the first end 7211 of the right first connector 721. During specific implementation, two ends of the first metal waveguide 73 may be fixedly connected to the first connector 711 and the second connector 751 by using connecting apparatuses such as fasteners, buckles, or flanges, and two ends of the second metal waveguide 74 may be fixedly connected to the first connector 721 and the second connector 751 by using connecting apparatuses such as fasteners, buckles, or flanges.

It should be noted that in the embodiment shown in FIG. 20, an equivalent dielectric constant at a first cross section of the first connector assembly 71 and an equivalent dielectric constant at a second cross section of the first connector assembly 71 may also be limited by using a relationship in the foregoing embodiment, and an equivalent dielectric constant at a first cross section of the second connector assembly 72 and an equivalent dielectric constant at a second cross section of the second connector assembly 72 may also be limited by using a relationship in the foregoing embodiment. Details are not described herein again.

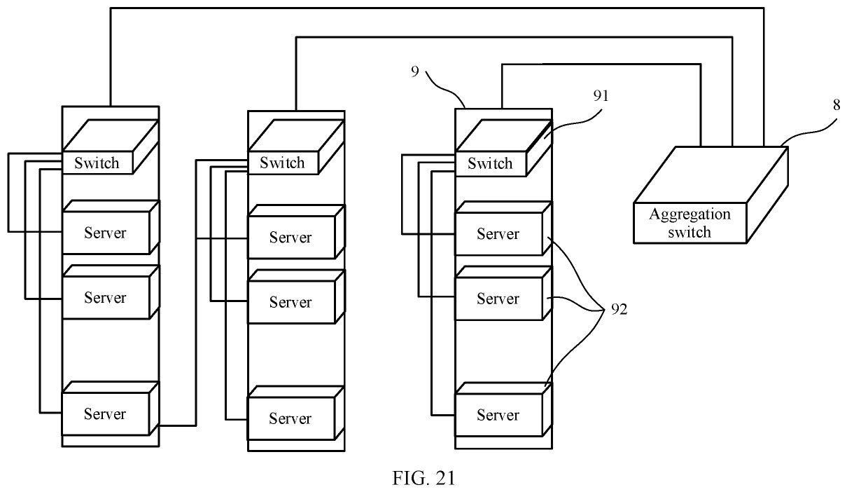

It should be understood that, in addition to being used in a vehicle, the signal transmission structure and the dielectric waveguide connection structure provided in embodiments of this application may also be used in another scenario that has a high requirement on a signal transmission rate, for example, a data center scenario. Based on this, an embodiment of this application may further provide an electronic device in which the foregoing signal transmission structure may be used. Refer to FIG. 21. The electronic device may include an aggregation switch 8 and a plurality of cabinets 9. A switch 91 and a plurality of servers 92 may be separately disposed in each cabinet 9. For each cabinet 9, the servers 92 and the switch 91 that are in the cabinet 9 may communicate with each other. For the entire electronic device, the switch 91 in each cabinet 9 may communicate with the aggregation switch 8. In a specific design, the electronic device may further include a transmitting module and a receiving module. The transmitting module may be electrically connected to both the switch 91 and the server 92, and is configured to: modulate a signal sent by the server 92 and a signal sent by the switch 91, and perform frequency shifting on the signals to specified high-frequency bands. The receiving module may be electrically connected to both the server 92 and the switch 91, and may be configured to: perform frequency conversion and demodulation on a high-frequency signal received from the server 92, convert the high-frequency signal into a signal in a frequency band that can be received by the switch 91, and send the high-frequency signal to the switch 91; and perform frequency conversion and demodulation on a high-frequency signal received from the switch 91, convert the high-frequency signal into a signal in a frequency band that can be received by the server 92, and send the signal to the server 92.

In addition, the transmitting module may be further electrically connected to the aggregation switch 8, and is configured to: modulate a signal sent by the aggregation switch 8, and perform frequency shifting on the signal to a specified high-frequency band. The receiving module may also be electrically connected to the aggregation switch 8, and may be configured to: perform frequency conversion and demodulation on a high-frequency signal received from the switch 91, convert the high-frequency signal into a signal in a frequency band that can be received by the aggregation switch 8, and send the signal to the aggregation switch 8.

The transmitting module and the receiving module may be connected by using the foregoing two signal transmission structures. A metal waveguide of one signal transmission structure is electrically connected to the transmitting module, a metal waveguide of the other signal transmission structure is electrically connected to the receiving module, and dielectric waveguides of the two signal transmission structures are also electrically connected. In this way, signal transmission can be implemented between the transmitting module and the receiving module.

It should be noted that, in actual application, the dielectric waveguides of the two signal transmission structures may be of an integrated structure, or may be of a split structure. This is not limited in this application. When the dielectric waveguides of the two signal transmission structures are of the split structure, end parts of the two dielectric waveguides may be electrically connected by using the dielectric waveguide connection structure provided in the foregoing embodiment, to ensure smooth communication between the switch and the server.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A signal transmission structure, comprising:
a connector comprising a first end and a second end that are oppositely disposed, wherein the connector has a first through hole extending from the first end to the second end, and the first through hole has a metal inner wall;
a metal waveguide having a second through hole, wherein one end of the metal waveguide is connected to the first end of the connector, and the second through hole communicates with the first through hole; and
a dielectric waveguide comprising a core and a cladding that covers an outer periphery of the core, wherein the dielectric waveguide has an insertion end that is inserted into the first through hole through the second end of the connector, the core has an extension segment extending out of the cladding at the insertion end of the dielectric waveguide, an end part of the extension segment extends into the second through hole and is spaced from an inner wall of the second through hole, and a cross-sectional area of the end part of the extension segment gradually decreases in a direction from the second end to the first end.

2. The signal transmission structure according to claim 1, further comprising a first cross section and a second cross section, wherein the first cross section is located between an end part of the cladding and the end part of the extension segment, the second cross section is located between the second end of the connector and the end part of the cladding, and an equivalent dielectric constant ε_{eff1} at the first cross section and an equivalent dielectric constant ε_{eff2} at the second cross section is configured to satisfy:
$$\\ \frac{\vert {ε}_{eff 2} - {ε}_{eff 1} \vert}{{ε}_{eff 2}} \times 100 \% \leq 20 \% .$$

3. The signal transmission structure according to claim 1, wherein:
the extension segment has a conical structure; or
the extension segment comprises a uniform segment and a gradient segment that are sequentially disposed away from the end part of the cladding, and the gradient segment has a conical structure.

4. The signal transmission structure according to claim 2, wherein:
an end of the second through hole and that is close to the connector has a first hole segment;
and an inner diameter of the first hole segment gradually increases in a direction from the first end of the second through hole to the second end of the connector.

5. The signal transmission structure according to claim 4, wherein a length of the first hole segment is greater than or equal to λₒ, wherein λₒ is a free space wavelength of an operating frequency of a to-be-transmitted signal.

6. The signal transmission structure according to claim 4, wherein an end part of the metal waveguide is inserted into the first through hole through the first end of the connector.

7. The signal transmission structure according to claim 6, wherein:
a protrusion is disposed on the inner wall of the first through hole, and the protrusion has a metal surface; and
at the insertion end of the dielectric waveguide, the end part of the cladding is in contact with a side of the protrusion and that faces the second end of the connector, and a peripheral side of a gradient segment is spaced from the protrusion.

8. The signal transmission structure according to claim 7, wherein:
the end part of the metal waveguide is in contact with a side of the protrusion and that faces the first end of the connector; or
the end part of the metal waveguide is spaced from a side of the protrusion and that faces the first end of the connector.

9. The signal transmission structure according to claim 7, wherein the protrusion has a ring-shaped structure.

10. The signal transmission structure according to claim 9, wherein an inner diameter of the second through hole is equal to an inner diameter of the protrusion at the end part of the metal waveguide and that is inserted into the first through hole.

11. The signal transmission structure according to claim 7, wherein:
the extension segment has a conical structure, wherein the first cross section is located between the end part of the cladding and the side of the protrusion that faces the first end of the connector; or
the extension segment comprises a uniform segment and the gradient segment, wherein the first cross section is located between the end part of the cladding and a first plane, the first plane is a plane closer to the first end of the connector in a plane in which an end of the uniform segment is connected to the gradient segment is located and a plane in which the side of the protrusion and that faces the first end of the connector is located.

12. The signal transmission structure according to claim 6, wherein:
the signal transmission structure further comprises a sleeve, and the insertion end of the dielectric waveguide is fastened in the sleeve;
an outer wall of the sleeve has a first limiting step, the sleeve is inserted into the first through hole through the second end of the connector, and the first limiting step abuts against the second end of the connector; and
the end part of the metal waveguide that is inserted into the first through hole abuts against an end part of the sleeve in the first through hole.

13. The signal transmission structure according to claim 12, wherein:
the extension segment has a conical structure, the first cross section is located between two ends of the first hole segment; or
the extension segment comprises a uniform segment and the gradient segment, the first cross section is located between the end part of the cladding and a second plane, wherein the second plane is a plane closer to the first end of the connector in a plane in which an end of the uniform segment is connected to the gradient segment is located and a plane in which an end part of the first hole segment and that is close to the first end of the connector is located.

14. The signal transmission structure according to claim 6, wherein:
an outer wall of the metal waveguide has a second limiting step, and the second limiting step abuts against the first end of the connector; and
the end part of the metal waveguide that is inserted into the first through hole abuts against the end part of the cladding in the first through hole.

15. The signal transmission structure according to claim 4, wherein an end part of the metal waveguide is in contact with and fixedly connected to the first end of the connector.

16. A dielectric waveguide connection structure, comprising:
a first connector assembly and a second connector assembly, wherein each of the first connector assembly and the second connector assembly comprises a first connector and a first dielectric waveguide, the first connector comprises a first end and a second end that are oppositely disposed, the first connector has a first through hole extending from the first end to the second end, and the first through hole has a metal inner wall, the first dielectric waveguide comprises a first core and a first cladding that covers an outer periphery of the first core, the first dielectric waveguide has an insertion end that is inserted into the first through hole through the second end of the first connector, the first core has a gradient segment extending out of the first cladding at the insertion end of the first dielectric waveguide, and a cross-sectional area of the gradient segment gradually decreases in a direction from the second end to the first end; and
a first metal waveguide having a second through hole, wherein one end of the first metal waveguide is connected to a first end of a first connector of the first connector assembly, the other end of the first metal waveguide is connected to a first end of a first connector of the second connector assembly, and a gradient segment of the first connector assembly and a gradient segment of the second connector assembly are separately inserted into the second through hole through two ends of the first metal waveguide.

17. The dielectric waveguide connection structure according to claim 16, wherein:
the second through hole comprises a first hole segment, a second hole segment, and a third hole segment;
the first hole segment is closer to the first connector assembly than the second hole segment;
the second hole segment is disposed closer to the second connector assembly than the first hole segment;
the third hole segment is located between the first hole segment and the second hole segment; and
an inner diameter of the first hole segment and an inner diameter of the second hole segment gradually increases in a direction away from the third hole segment.

18. The dielectric waveguide connection structure according to claim 17, wherein a length of the first hole segment is greater than or equal to λₒ, a length of the second hole segment is greater than or equal to λₒ, or a length of the third hole segment is greater than or equal to λₒ, wherein λₒ is a free space wavelength of an operating frequency of a to-be-transmitted signal.

19. A vehicle, comprising:
a sensor configured to detect movement information of the vehicle;
a transmitter electrically connected to the sensor, and configured to modulate a detection signal of the sensor into a high-frequency signal;
two signal transmission structures, wherein each signal transmission structure comprises:
a connector comprising a first end and a second end that are oppositely disposed, wherein the connector is provided with a first through hole extending from the first end to the second end, and the first through hole has a metal inner wall,
a metal waveguide having a second through hole, wherein one end of the metal waveguide is connected to the first end of the connector, and the second through hole communicates with the first through hole, and
a dielectric waveguide comprising a core and a cladding that covers an outer periphery of the core, wherein the dielectric waveguide has an insertion end that is inserted into the first through hole through the second end of the connector, the core has an extension segment extending out of the cladding at the insertion end of the dielectric waveguide, an end part of the extension segment extends into the second through hole and is spaced from an inner wall of the second through hole, and a cross-sectional area of the end part of the extension segment gradually decreases in a direction from the second end to the first end;
an electronic control circuit; and
a receiver electrically connected to the electronic control circuit, and configured to: demodulate a received high-frequency signal, and send the demodulated signal to the electronic control circuit, wherein the metal waveguide of a first signal transmission structure of the two transmission structures is electrically connected to the transmitter, the metal waveguide of a second signal transmission structure of the two transmission structures is electrically connected to the receiver, and dielectric waveguides of the two signal transmission structures are electrically connected.

20. An electronic device, comprising:
a server;
a switch;
a transmitter is electrically connected to the server and to the switch, the transmitter configured to modulate a signal sent by the server and a signal sent by the switch into high-frequency signals;
two signal transmission structures, wherein each of the two signal transmission structures comprises:
a connector comprising a first end and a second end that are oppositely disposed, the connector is provided with a first through hole extending from the first end to the second end, and the first through hole has a metal inner wall,
a metal waveguide having a second through hole, wherein one end of the metal waveguide is connected to the first end of the connector, and the second through hole communicates with the first through hole,
a dielectric waveguide comprising a core and a cladding that covers an outer periphery of the core, wherein the dielectric waveguide has an insertion end that is inserted into the first through hole through the second end of the connector, the core has an extension segment extending out of the cladding at the insertion end of the dielectric waveguide, an end part of the extension segment extends into the second through hole and is spaced from an inner wall of the second through hole, and a cross-sectional area of the end part of the extension segment gradually decreases in a direction from the second end to the first end, and
a receiver electrically connected to both the server and the switch, and is configured to: demodulate a high-frequency signal received from the server, send the demodulated signal to the switch, demodulate a high-frequency signal received from the switch, and send the demodulated signal to the server, wherein the metal waveguide of one signal transmission structure is electrically connected to the transmitter, the metal waveguide of the other signal transmission structure is electrically connected to the receiver, and dielectric waveguides of the two signal transmission structures are electrically connected.
